(19) United States
(12) Patent Application Publication
(10) Pub. No.: US 2026/0002545 A1
(43) Pub. Date: Jan. 1, 2026

(54) Water Pump Drain Plug System

(71) Applicant: Timothy A. Dedrick, Medford, OR (US)

(72) Inventor: Timothy A. Dedrick, Medford, OR (US)

(21) Appl. No.: 19/322,618

(22) Filed: Sep. 8, 2025

Related U.S. Application Data
(63) Continuation of application No. 17/308,429, filed on May 5, 2021, now abandoned.
(60) Provisional application No. 63/030,624, filed on May 27, 2020.

(51) Int. Cl. F04D 29/00; F01M 11/04; F16K 17/18; F16L 55/11; F16N 31/00

(52) U.S. Cl. CPC F04D 29/00; F16K 17/18; F16L 55/1141; F16N 31/002; F01M 2011/0416; F05D 2260/602

(57) ABSTRACT

A water pump drain plug has a first end which is adapted for engagement to a water pump drain opening which communicates with the pressurized fluid within the water pump. The drain plug has an axial passage communicating therethrough capable of draining fluid from the water pump. The axial passage is plugged initially by a sealing member engaged therein which will release upon communication of fluid pressure against it at a predetermined release pressure.

This application a continuation application to U.S. patent Application Ser. No. 17/308,429 which claims priority to U.S. Provisional Patent application Ser. No. 63/030,624 filed on May 27, 2020, which is incorporated herein in its entirety by this reference thereto.

### BACKGROUND OF THE INVENTION

### 1. Field of the Invention

The present invention relates generally to water pumps. More particularly, it relates to a protective drain plug for above ground water pumps which is configured for removable sealed engagement within a conventional drain opening of the water pump, and which is employable both to provide a conventional sealed plug engagement and to prevent damage to a water pump during freezing conditions.

### 2. Prior Art

Water pumps are widely employed to provide pressurized water flow to a wide variety of components and devices. Such pumps come in a wide variety of configurations. In some cases, the water pump is engaged within or attached to engines to provide cooling. Some water pumps are configured to be submersed in water or other fluid and to pump the fluid through engaged conduits. Other water pumps are themselves operatively engaged with an engine or electric motor and are positioned above ground and water and pump water from an intake conduit in communication with a water supply, into an outflow conduit which communicates with a device or spigot needing pressurized water.

Above ground water pumps, for example, are employed commercially for construction, mining, and in many other situations where a constant pressurized flow of water is needed. However, because above ground water pumps are exposed to the elements and air surrounding them, they can be severely damaged when located in an area of freezing conditions. This is because water will expand approximately nine percent when it changes from a fluid to a solid in the form of ice. Should such freezing occur without precautions being taken, the force of expanding water can crack or otherwise damage the pump itself. Such expansion can then exert a force between 25,000 and 114,000 psi (pounds per square inch) against the sidewall of the water pump surrounding the internal cavity of the water pump.

In areas where above ground pumps are employed, winterizing them to prevent such damage is a task which must be accomplished unerringly. Such conventionally involves the removal of a drain plug which is engaged in an opening in the sidewall of the pump. This opening communicates through the sidewall between an interior chamber of the pump and the air surrounding the sidewall. Where the drain plug is removed, as a protective measure where freezing temperatures are anticipated, it will normally allow a portion of the expanding water to exit through the opening and thereby prevent structural damage to the pump housing.

However, the task of drain plug removal is one that is easily forgotten by pump owners, or such can easily be missed by workers tasked with the job. Further, drain plugs are supposed to be left mounted for operation of the pump and only rarely removed to drain the pump. Consequently, pumps exposed to freezing temperatures, where the drain plug has not been removed from the drain opening of the pump, are subject to extreme damage from the expansion of water within them.

Additionally, where the drain plug has been removed by conscientious workers or pump owners another problem arises. Because such plugs are small and easily lost, when weather conditions are such that the pump can be run, it is a frequent occurrence that the plug cannot be found. Such presents an extreme and expensive problem when the pump is located in a remote location.

Such water pump drain plugs conventionally have threads running on the exterior circumference thereof which extend from a first end or engagement end of the plug toward a distal or second end of the drain plug. These circumferentially positioned plug threads are sized to form a sealed engagement with the opening threads which are positioned on the interior circumferential surface of the drain opening communicating through a wall forming the water pump housing. When such metal drain plugs are removed, water currently within the cavity of the water pump defined by the wall of the housing, will drain through the opening from the drain opening.

In addition to damage to the water pump caused by freezing water currently occupying the internal cavity, where a water pump is operatively attached to or remains a part of a larger water supply system, remnant water in the system conduits can eventually trickle down through the machinery to the lowest point in the system, which conventionally is the internal cavity of the water pump.

While removing the drainplug and draining water from the pump internal cavity will prevent such damage, in order not to lose the drain plug, many pump system operators or pump maintenance people replace the drainplug into its place after the preventive or seasonal draining of the water pump believing they have winterized it. Such a preventive system of removing and replacing the drain plug places the pumping system in extreme jeopardy. This is because the user believes the pump internal cavity is drained. However, frequently remnant water in connected conduits or new water can enter or trickle down from within the pumping system and into the vulnerable internal cavity of the water pump volute-body. As such, while the pump user may believe they have winterized the water pump, the reentering water can subsequently cause freezing and cracking of the wall of the pump volute-body. Such will render the pump non-operational and worthless.

With respect to the above, before explaining at least one preferred embodiment of the water pump drain plug system herein, it should be understood that the disclosed device and system are not limited in application to the details of employment and to the arrangement of the components or the steps set forth in the following description or illustrated in the drawings. The various apparatus and operations of the herein disclosed drain plug system herein are capable of other embodiments, and of being practiced and carried out in various ways, all of which will be obvious to those skilled in the art once the information herein is reviewed.

Also, it is to be understood that the phraseology and terminology employed herein are for the purpose of description, and should not be regarded in any fashion as limiting. As such, those skilled in the art will appreciate that the conception upon which this disclosure is based, may readily be utilized as a basis for other water pump drain plug devices and system. It is important, therefore, that the embodiments, objects and claims herein, be regarded as including such equivalent construction and methodology insofar as they do not depart from the spirit and scope of the present invention.

### SUMMARY OF THE INVENTION

The device herein provides a freeze damage preventing drain plug system for water pumps which is configured on a first end for a threaded engagement within the conventional threaded drain opening of a conventional water pump into which a solid drain plug is conventionally engaged during use of the water pump. It additionally provides an over pressure release to prevent pump damage from operating above prescribed maximum pressure limits. Such conventional drain plugs, as noted above, are solid and fixed in engagement during pump use and are conventionally only removed by the user to drain the water from the water pump in which they are positioned. Otherwise, they are formed of solid metal and left in place for the duration of pump operation.

The drain plug herein, instead of being formed of solid metal in the manner of conventional drain plugs, is formed with an axial passage communicating through the body of the drain plug. This axial passage runs from a first opening on a first end of the drain plug which is in communication with the internal cavity of a water pump, to a second opening at the second end of the body of the drain plug.

The drain plug herein preferably includes engagement threads formed around the circumferential exterior surface of the plug body. The engagement threads extend circumferentially from the first end of the plug toward the second end thereof. These engagement threads are configured for threaded engagement into a threaded opening communicating through the sidewall of a water pump which communicates into the interior cavity of the water pump which contains water. Such a threaded configuration insures widespread use to protect pumps by employing the conventional means for engagement of such plugs.

Once the engagement threads on the first end of the body of the drain plug herein are operatively located within the threaded drain opening of the water pump sidewall, the drain plug herein is located to an as-used positioning. In this as-used positioning, a seal is formed which prevents water from exiting the water pump through the threaded drain opening in the sidewall during normal operation thereof.

Within or at the second opening communicating with the axial passage running through the body of the drain plug herein, is positioned a sealing member. The sealing member is preferably formed of polymeric, plastic, or other non metallic material which is configured to burst or deform and release from its engagement to the second opening or from engagement within the axial passage.

By polymeric, plastic, or other non metallic material is meant elastomers with a shore hardiness between 20 A-100 A. The exact shore used will depend upon the amount of deformation, deflection or shear resistance required to maintain the sealing member in a sealed position up to the predetermined release pressure where the sealing member will deform and release from sealed engagement. Determining the resistance of elastomers and the shore to achieve such is a well known art and can be calculated with great accuracy to form the body of the sealing member of the elastomer such as polymeric or plastic material which will have thereon a pressure released connector which will deform, sever, and disengage the mount of the sealing member at the predetermined release pressure and thereby allow exiting of pressurized fluid from the pump communicating with the drain opening.

Where placed in a seal at the second opening, the sealing member may also be formed in a wall configuration and in this configuration may also be formed of metal or polymeric or plastic material, which is in a thickness calculated to burst at a pressure level designated to protect the pump from damage. Where the seal is positioned within the second opening and/or portions of the axial passage, it is an elastomer material preferably formed of the polymeric, plastic, metal, or other material which has a connector which will shear or deform and disengaged from a removable engagement. On this disengagement, the seal will eject from the second opening at the second end of the body of the drain plug, upon the communication of pressure to the first opening which equals or exceeds the predetermined pressure level. By connector herein is meant thread projections or annular projections or other projections extending from the polymeric material which will deform, break, shear, and/or bend at the predetermined pressure level exerted upon the sealing member, causing it to disengage from the drain plug herein.

This predetermined release pressure level is generally dependent on the normal operating pressures of the pump itself. Currently, the mode of the device which in experimentation has shown to work with the widest variety of water pumps has a release pressure is 650-800 pounds per square inch, with substantially 800 PSI being a particular favorite. It was found unexpectedly in experimentation that a release pressure below 650 PSI tended to disengage too easily, especially during pressure surges that occur with such pumps. Using a release pressure between 650-800 PSI better allowed for such surges, especially when operating in areas with higher temperatures such as deserts, to allow the pump to operate over-pressure such as during surges. For a single choice, substantially 800 PSI during experimentation was shown to allow for operation of the pump in cold temperatures as well as warmer temperatures but still allow protection from prolonged over-pressure operation and also from freezing.

For a drain plug with a customized release pressure level, it can be formed and provided to the user either individually or in a kit where the pressure where the sealing member releases is at least 50 and more preferably 200 PSI above the normal operating pressure levels of the pump is favored since many water pumps will operate on occasion above their specified operating pressures. Such will allow the pump to run under normal conditions where water therein is not frozen but will cause the sealing member to burst or to deform the connector and lose its engagement and eject from the second opening of the plug herein, once that maximum or release pressure level is exceeded.

This configuration will, thus, protect the pump should the user fail to remove the drain plug prior to temperature freezing the water within the internal cavity of the pump. Further, it will allow for over-pressure protection during use and will allow the user to drain the water pump by removing the drain plug prior to a freezing occurrence in a conventional fashion. Additionally, should the drain plug herein be replaced after a draining of the pump, the pump will still be protected should residual water fill the internal cavity and freeze, or should the pump operate over the maximum pressure.

With respect to the above description, before explaining at least one preferred embodiment of the herein disclosed water pump drain plugs in detail, it is to be understood that the invention is not limited in its application to the details of construction and to the arrangement of the components in the following description or illustrated in the drawings. The invention herein described, is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other water pump drain plugs and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise specifically defined for size or dimension or positioning of a specific part or configuration, means plus or minus ten percent.

It is an object of this invention to provide a drain plug which is engageable within the drain plug opening of a conventional water pump and which will prevent structural damage to the pump from freezing water therein.

Another object of this invention is to provide such a drain plug which can be left operatively engaged with a water pump and which will provide for the release of both over pressure water during operation and expanding water during freezing temperature.

An additional object of the invention herein is the provision of drain plugs having structural components which will automatically open a fluid path through the drain plug during freezing temperature.

A further object of the invention is the provision of a protective drain plug for water pumps which includes a replaceable sealing member, which allows the user to reseal an opened drain plug for reuse.

Other objects, features, and advantages of the presently disclosed drain plug device and system herein, as well as the advantages thereof over existing prior art, will become apparent from the description to follow, and are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the various mode of the water pump drain plug system herein. It is intended that the embodiments and figures disclosed herein are to be considered illustrative rather than limiting.

In the drawings:

FIG. 1 depicts one preferred mode of the drain plug device herein, showing a sealing member positioned in sealed engagement with a second opening in the body of the drain plug.

FIG. 2 shows a sectional view through FIG. 1.

FIG. 3 shows a mode of the drain plug device herein, having a sealing member removably positioned within the second opening at the second end of the axial passage communicating through the body.

FIG. 4 shows a sectional view of the drain plug of FIG. 3 depicting an annular projection at a second end of the sealing member which projects a longer distance than a circumference of the body of the member to contact an endwall and is configured to deform and release the sealing member once pressure within the axial passage equals or exceeds a release pressure.

FIG. 5A shows a mode of the device herein wherein an engageable end cap threadably engages with a projection surrounding the second opening and has a sealing member on an endwall thereof.

FIG. 5B depicts the device as in 5A disassembled.

FIG. 5C shows the endwall of the cap having the sealing member positioned therein.

FIG. 5D shows a perspective view of the device as in 5A.

FIG. 6A depicts a mode of the device similar to that of 5A wherein a cap engages with the second end of the body and holds the sealing member in sealed engagement over the second opening.

FIG. 6B depicts an exploded view of FIG. 6A.

FIG. 6C shows a perspective end view of the device as in FIG. 6A.

FIG. 7 shows a mode of the device having a removably engageable sealing member connected with the second opening of the body of the drain plug.

FIG. 8 depicts an exploded sectional view of the device of FIG. 7 showing the threadably engageable sealing member positioned for threaded engagement within the second opening.

FIG. 9 shows the device as in FIG. 7-8 with the inclusion of a second sealing member in a removable connection to the body of the device.

FIG. 10 depicts the device herein in a kit form where a plurality of different sealing members are provided which are formed with a connector to engage them to the body of the plug where each is marked to show the relapse pressure level of the respective plug.

Other aspects of the present drain plug device and system herein shall be more readily understood when considered in conjunction with the accompanying drawings, and the following detailed description, neither of which should be considered limiting.

### DETAILED DESCRIPTION OF THE PREFERRED

### Embodiments of the Invention

In this description, the directional prepositions of up, upwardly, down, downwardly, front, back, top, upper, bottom, lower, left, right, first, second, and other such terms refer to the drain plug device as it is oriented and appears in the drawings and are used for convenience only, and they are not intended to be limiting or to imply that the drain plug has to be used or positioned in any particular orientation.

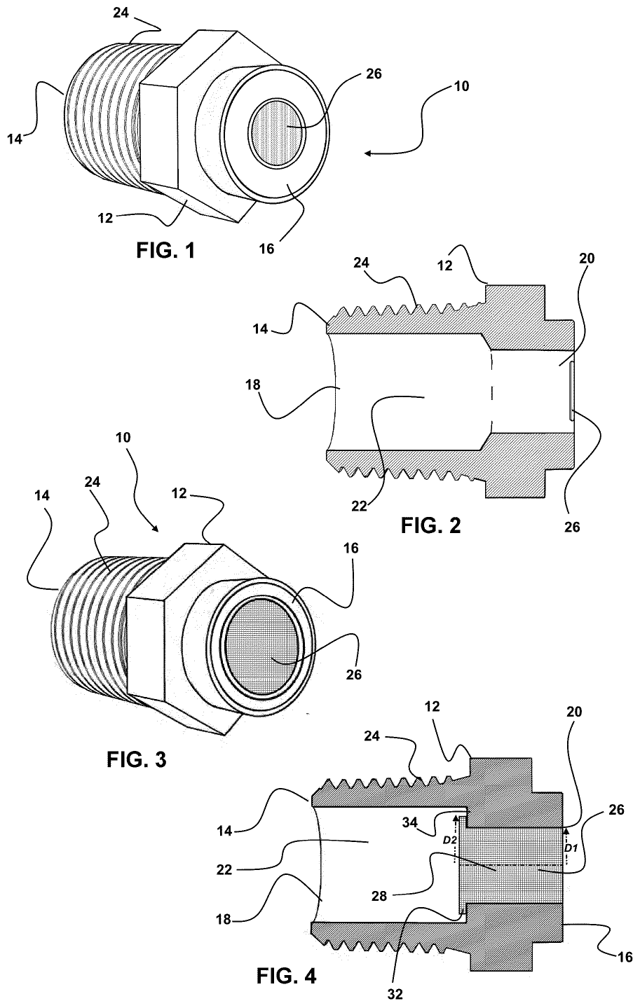

Now referring to drawings in FIGS. 1-10, where similar components of the device 10 herein are identified by like reference numerals. In all modes of the device 10 herein, the device 10 has a body 12 which has a first end 14 opposite a second end 16 thereof. A first opening 18 is positioned at the first end of the body 12 opposite a second opening 20 at the second end of the body 12. An axial passage 22 communicates through the body 12 between the first opening 18 and second opening 20.

The first end 14 of the body 12 of the device 10 is configured for a sealed engagement with a drain opening of a water pump. Currently, threads 24 positioned on the body 12 extending from the first end 14 toward the second end 16 provide for such a sealed engagement in a conventional fashion. As noted above, the drain opening of a pump, conventionally, is internally threaded and the threads 24 on the body 12 herein are configured to engage with the drain opening threads and position the device 10 in an as-used positioning with a water pump. While not shown, such a threaded sealed engagement is well known.

In this as-used positioning, the first opening 18 is in communication directly or through an internal pathway with the internal cavity of a water pump. A pressurized fluid stream from water within the internal cavity, or generated by water within the internal cavity of the pump, is communicated into the first opening 18 through the axial passage 22 in the body 12 and thereby communicated to the second opening 20 at the second end 16 of the body 12 of the device 10. Such a pressurized fluid stream will generally be water itself under pressure from freezing or pump action but can include any air or gas within the axial passage 22 also.

Common to all modes of the device 10, at the second end 16 of the body 12, in a sealed engagement with the second opening 16, is positioned a sealing member 26. This sealing member 26 is in a pressure released connector in or with the second opening 20. By pressure released connector is meant a sealed connection between the sealing member 26 and the body 12 of the device 10, which prevents the fluid stream communicated into the axial passage 22 from exiting the body 12 through the second opening 20 until the internal pressure of the fluid stream within the axial passage 22 which is communicated to the second opening 20 exceeds a predetermined release pressure, wherein the sealing member 26 bursts or a pressure released connector deforms, shears, or otherwise releases the connection to the body 12. Such a pressure released connector, for example and in no way limiting, can include threads 24, or annular projections 32 contacting an endwall 34, whereby the sealing member 26 is ejected by fluid pressure thereon, releasing the sealing member from a sealed engagement of the second opening 20.

By predetermined release pressure is meant a fluid pressure of the fluid stream within the axial passage 22, and/or which is communicated against the sealing member 26 sealing the second opening 20, which is 650-800 PSI for a mode of the device 10 herein shown during experimentation to protect against both over-pressure operation and freezing, with 800 PSI being a particular favorite to allow the pump to surge for a duration during operation without dismounting the sealing member 26 unless the pressure reaches 800 PSI.

For a customized mode of the device 10 in custom or kit form, the predetermined release pressure will be at least 50 PSI and more preferred at least 200 PSI above the normal operating fluid pressure of the water pump within the internal cavity thereof to which the device 10 herein is operatively engaged in an as-used positioning. Such a nominal operating pressure is conventionally posted on labels on the water pump itself, or in the specification booklet, or manual provided with the respective water pump and easily determined.

Thus, once pressure of the fluid stream communicated through the first opening 18 and into the axial passage 22 and against the sealing member 26 in the pressure-released engagement of the pressure-released connector with the second opening 20 or within the axial passage 22 reaches the predetermined release pressure level, the sealing member 26 will release. Such a release will occur by bursting of the body of the sealing member, if formed planar, or by a disengagement of the body 12 from sealed engagement with the second opening 20, whereby the sealing member 26 will no longer block fluid flow from the second opening 20 from the axial passage 22.

Such a release of the sealing member 26 in this pressure released engagement of a pressure released connector, in all modes of the device 10, allows the pressurized fluid stream within the axial passage 22 to flow through the second opening 20 and out of the body 12 of the device 10. This fluid flow continues as long as there is a pressurized fluid stream communicated through the first opening 18 into the axial passage 22. It provides protection from over-pressure operation of the water pump as well as from freezing.

As shown in FIGS. 1-3, the sealing member 26 is positioned in the pressure released engagement of the pressure released connector such as the annular projection 32 at the communication of the second opening 20 with the second end 16 of the body 12 of the device 10. As shown in FIG. 2, the sealing member 26 is formed in a layer or thickness which is configured to burst once the fluid stream contacting it from the axial passage 22 reaches or exceeds the predetermined release pressure. By varying the thickness and material forming this mode of the sealing member 26, it can be formed to burst at the predetermined release pressure of either 800 PSI or the customized determined PSI. For example, by forming it from a metal with known failure properties or from a polymeric or other non metallic material with known failure or burst properties. Once the device 10, as in FIGS. 1-2, fails, it must be entirely replaced.

In FIGS. 3-4 is shown a mode of the drain plug device herein, wherein the sealing member 26 has an elongated seal body 28 extending a first distance D1 from the axis thereof to a circumferential wall. The circumferential wall extending the first distance D1 has a diameter sized to form a sealed contact against an interior wall 30 of the second opening 16.

An annular projection 32 extends perpendicular to the axis for a second distance D2 which exceeds the first distance D1 of the circumferential wall of the seal body 28 of the sealing member 26. The annular projection 32, as shown, is, thus, larger in diameter than the diameter of the circumferential wall and that of the second opening 20. So configured, the annular projection 32 forms a contact of the annular projection 32 against an interior wall 34 at a second end of the axial passage 22.

This contact of the annular projection 32 prevents the sliding disengagement of the sealing member 26 from sealing the second opening until the pressurized fluid stream, communicated into the axial passage 22, reaches or exceeds the predetermined release pressure. At that point, based on the shore hardness of the polymeric material forming the sealing member 26 and the distance D2 of projection, the annular projection 32, forming the pressure released connector, will either detach or deform and bend toward a center axis of the seal body 28 of the sealing member 26, and the sealing member 26 will be ejected from the second opening 20. The same sealing member 26, if undamaged after dismount, or a new one, can be reinserted by folding the annular projection 32 toward the center axis of the sealing body 28 while entering pressure on the side of the sealing body which is opposite the annular projection 32 or by insertion through the first opening 18.

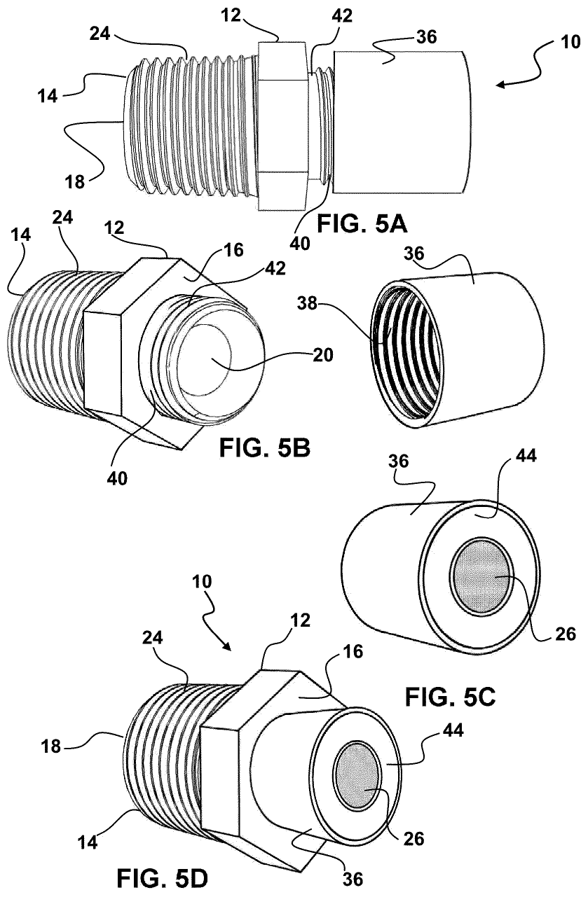

FIGS. 5A-5D show a mode of the device 10 herein, wherein the sealing member 26 is engaged with a cap 36. A threaded opening 38 at a first end of this cap 36 is configured to form a sealed engagement with secondary threads 40 formed upon a projection 42 which surrounds the second opening 20.

As shown, the sealing member 26 is or forms part of an endwall 44 at a second end of the cap 36 opposite the threaded opening 38. With the cap 36 engaged by the threaded opening 38 upon the secondary threads 40 surrounding the projection 42, the second opening 20 is sealed from any fluid flow therethrough by the positioning of the endwall and sealing member 26 therein. The sealing member 26 in the endwall 44 is formed and operates the same as that of FIG. 1, in that it is of a thickness and of a polymeric material configured to burst at the predetermined release pressure. However, unlike the device of FIG. 1-2, a new sealing member 26 can be preengaged to seal the second opening 20 by screwing on a new cap 36 having the appropriately configured sealing member 26 adapted to burst at the predetermined release pressure for the device 10 in operative engagement with the drain opening of the chosen water pump.

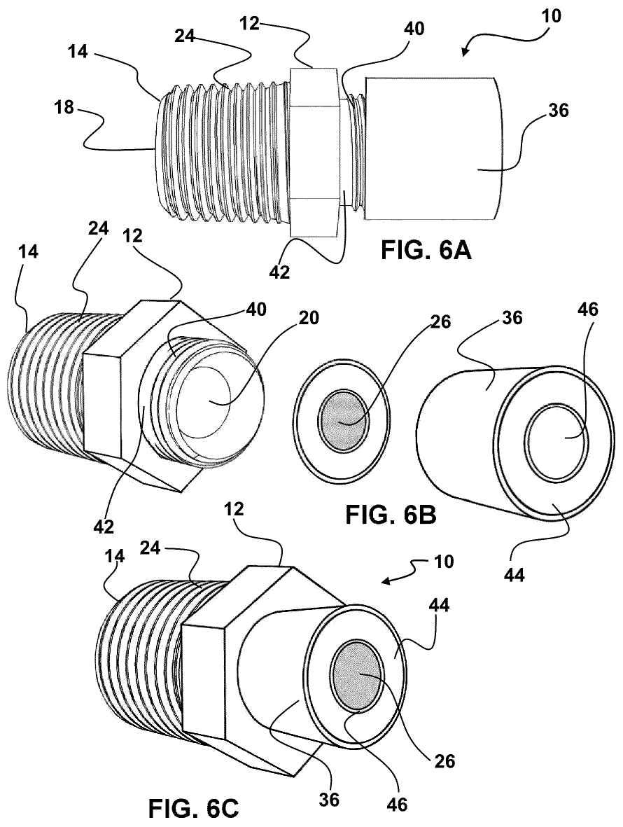

The device 10 as in FIGS. 6A-6C is configured to operate the same as that of FIGS. 5A-5D, except that the cap 36 has an aperture 46 formed in the endwall 44 which aligns with the sealing member 26 which is formed as a planar disk. With the cap 36 engaged as shown in FIG. 6C, the planar disk forming the sealing member 26 seals the second opening 20 from any pressurized fluid flow therethrough. The sealing member 26 is formed in a fashion much the same as that shown in FIGS. 5A-5D, and FIG. 1, in that it is of a thickness and metal or preferably polymeric material adapted to burst or dismount once the fluid stream from the axial passage 22 reaches the predetermined release pressure. Should such occur, a new sealing member 26, in the disk form shown, can be placed over the second opening 20 and the cap 36 reengaged with the projection 42 to hold the sealing member in a sealed engagement between the cap 36 and the second end 16 of the body 12.

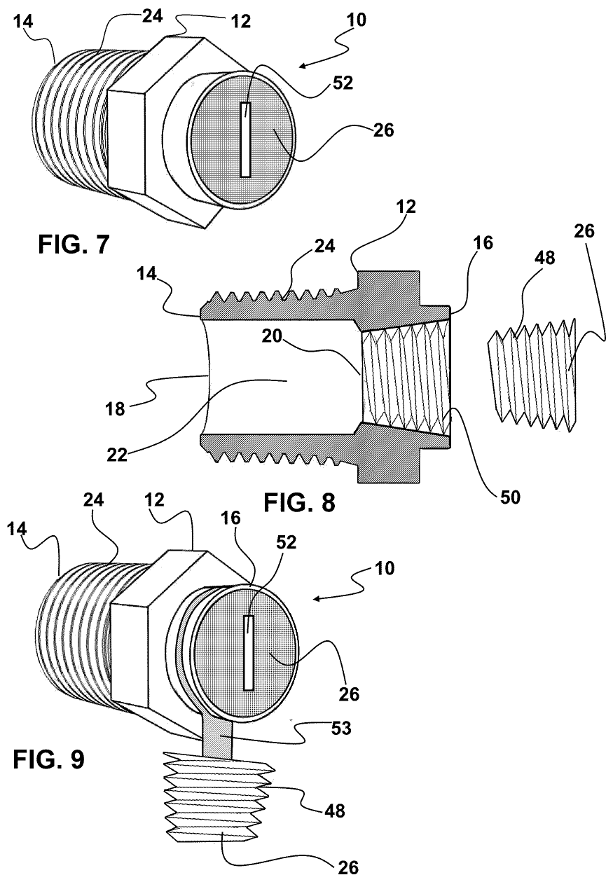

Shown in FIGS. 7-9 is a mode of the device 10, wherein the sealing member 26 is configured with member threads 48 which are configured to form the pressure released connector which will detach or will shear-off when fluid at the predetermined release pressure, of either 800 PSI or a customized PSI contacts the sealing member 26. As with the other modes of the device 10, the polymeric material forming the elastomeric sealing member 26 will be of a shore hardness such as between 20 A-100 A shore, whereupon the threads 48 will either shear or flex and dismount once the predetermined release pressure is reached.

The threads 48 extend a distance and in a thread pattern to form a sealed engagement with internal threads 40 formed in the wall surrounding the second opening 20. As shown in FIG. 8, the sealing member 26 may be rotated to engage the two sets of threads 24 and 50, to form the pressure released connector and position the sealing member 26 in the pressure released sealed engagement with the body 12 thereby preventing fluid flow through the second opening 20. A tool connector 52 such as a recess in the shape complimentary to the tool used, allows the user to rotate the sealing member 26 into position as in FIGS. 7 and 9. The length of the member threads 48 and the material forming the sealing member 26 are formed to enable the member threads 48 to bend and release from threaded engagement from the internal threads 50 once the fluid flow in the axial passage 22 reaches the release pressure.

The elastomeric sealing member 26, as noted, is formed of a polymeric or similar pliable plastic or other elastomeric material with a shore which will flex upon communication of fluid pressure against the sealing member 26. This flexure can be controlled in a calculated fashion by forming the sealing member of a polymeric material with a higher or lower durometer or shore hardness of the elastomer or polymeric material in a manner well known in the art. Thus, the width, number, and the deepness of the threads 48, in combination with the determined shore hardness of the polymeric material, can form the sealing member 26 in a fashion where the threads 48 will either shear off or will flex and bend sufficiently to detach from their threaded engagement with body threads 50, upon communication of the fluid pressure at the predetermined release pressure against the body of the sealing member 26.

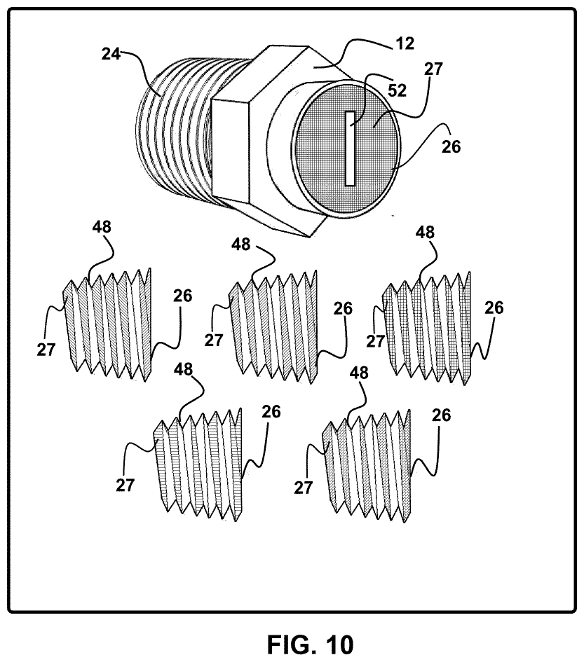

The sealing members 26, thus, can be provided in kit form as in FIG. 10 where each sealing member 26 is formed of material with a consecutively higher shore hardness and threads 48 which is calculated to deform and detach the threads 48 from engagement with body threads 50, at a consecutively different predetermined release pressure of the water pump. This will allow the user to choose the appropriate one of the kit of sealing members 26, which will resist the fluid pressure in the water pump, up to the predetermined release pressure desired. As noted, this is at least 50 PSI above the posted or specified operating pressure of the water pump, and in most instances more preferably at least 200 PSI above the specified operating pressure to allow for pressure surges without dismount.

In FIG. 9 is shown an especially preferred mode of the device 10 wherein a spare sealing member 26 is removably engaged to the body 12 of the device 10. As shown, a tether 53 such as an elastic band holds the spare sealing member 26 to the body 12 for use when needed. This tether 53 can also be employed to hold spare sealing members 26, such as those in FIG. 4 or 5C or 6B, where the tether 53 would be configured to removably engage therewith. The tether 53 will allow the same sealing member 26 to be re engaged where it has not been damaged and allow the user to do so. Such would be most preferred where the device 10 is used in remote areas where spare parts are not available.

Shown in FIG. 10 is a particularly preferred mode of the plug device 10 herein which is provided in a kit form. As shown, a plurality of different sealing members 26 are provided in the kit enabling the user to choose the sealing member 26 with a predetermined release pressure required for normal operation of the water pump but which will release when a pressure level at or above the predetermined relapse pressure is communicated to the sealing member 26.

As shown, the body 12 of the plug is provided which is configured to removably engage with each respective sealing member 26 in the kit. Each sealing member 26 in the kit is marked with indicia 27 which correlates to a specific predetermined release pressure at which the pressure released connector such as threads 24 or the annular projection 32 (FIG. 4) of the respective sealing member 26 will deform by bending toward the center of the axial passage 22, and release from engagement to the body 12, and open the axial passage 22 to allow water to escape therethrough. As shown, threads 24 form the pressure released connector for the depicted kit, however, it may also be employed with the annular projection 32 such as in FIG. 4. The indicia 27, while shown as color or patterns, may also be simple text molded into a wall surface of the formed sealing member 26.

In a method of use of the device 10 as in FIG. 10, the user will choose a predetermined release pressure for the water pump into which the body 12 will be engaged in a drain opening. Such may be a body 12 with a sealing member 26 which releases at 800 PSI and is marked as such. Alternatively, for use with a more customized approach, the predetermined release pressure desired by the user can be determined and chosen by reviewing the operating pressure specifications for the water pump for which the device 10 will be engaged and then determining the operating pressure for that pump. Then the user will choose the sealing member 26 in the kit which is marked with indicia 27 indicating that respective sealing member 26, from the kit being chosen, correlates to a specific predetermined release pressure the user wishes to employ with the specific water pump.

In a third step the user will engage the chosen sealing member 26 with the body 12 which will be, or is already operatively engaged with the water pump of choice. A chart, not shown but well known, which depicts the indicia 27 located on each sealing member 26 in the kit, can be provided when color or patterns are employed as the indicia 27. Where alphanumeric characters are employed as the indicia 27, such as on a planar wall surrounding the tool connector 52, the release pressure of the respective sealing member 26 in the kit may just be read by the user, prior to choosing the appropriate respective sealing member 26 from the kit.

It should be noted and anticipated that although the drain plug system is shown in its most simple form and potential configurations, various components and aspects of the disclosed drain plug device and system may be differently shaped or slightly modified when forming the invention herein. As such, those skilled in the art will appreciate the descriptions and depictions set forth in this disclosure are merely meant to portray examples of preferred modes of the device and system herein within the overall scope and intent of the invention, and are not to be considered limiting in any manner.

Further, while all of the fundamental characteristics and features of the water pump drain plug system invention have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A water pump drain plug, comprising:
a plug body, said plug body having a first end opposite a second end thereof;
an axial passage communicating from a first opening at said first end of said plug body to a second opening at said second end of said plug body;
said first end of said plug body removably engageable with a drain opening of a water pump for generating pressurized fluid;
a sealing member, said sealing member having a body formed of elastomeric material;
said body of said sealing member having member threads formed around a circumferential exterior surface thereof;
said member threads for forming a threaded engagement with internal threads surrounding said second opening for holding said sealing member in an engaged position therein;
said sealing member in said engaged position forming a fluid seal preventing communication of said pressurized fluid through said second opening;
said member threads defining a pressure released connector for said sealing member which detaches from said threaded engagement upon contact of said sealing member with said pressurized fluid at a predetermined release pressure thereof; and
whereby said pressurized fluid flow communicates through said second opening.

2. The water pump drain plug of claim 1 further comprising:
said elastomeric material being a polymeric, plastic, or another non-metallic material having a shore hardiness between 20 A-100 A.

3. The water pump drain plug of claim 1, additionally a tool connecter positioned on said sealing member body; and
said sealing member being positionable to said engaged position by rotation of said body of said sealing member to engage said member threads with said internal threads using a tool in a removable engagement with said tool connector.

4. The water pump drain plug of claim 2, additionally a tool connecter positioned on said sealing member body; and
said sealing member being positionable to said engaged position by rotation of said body of said sealing member to engage said member threads with said internal threads using a tool in a removable engagement with said tool connector.

5. The water pump drain plug of claim 4, additionally comprising:
said sealing member body having a tether extending therefrom; and
said tether engageable with said plug body to hold said sealing member proximate to said plug body upon being ejected therefrom.

6. The water pump drain plug of claim 4, additionally comprising:
said sealing member body having a tether extending therefrom; and
said tether engageable with said plug body to hold said sealing member proximate to said plug body upon being ejected therefrom.

7. The water pump drain plug of claim 5, additionally comprising:
said sealing member body having a tether extending therefrom; and
said tether engageable with said plug body to hold said sealing member proximate to said plug body upon being ejected therefrom.

8. The water pump drain plug of claim 6, additionally comprising:
a kit, said kit including a plurality of said sealing members; and
each of said plurality of sealing members having a respective said tether thereon; and
a first sealing member from said kit positionable to said engaged position and a second sealing member from said kit concurrently as a spare with said tether engaged with said plug body.

9. The water pump drain plug of claim 7, additionally comprising:
a kit, said kit including a plurality of said sealing members; and
each of said plurality of sealing members having a respective said tether thereon; and
a first sealing member from said kit positionable to said engaged position and a second sealing member from said kit concurrently as a spare with said tether engaged with said plug body.

10. The water pump drain plug of claim 8, additionally comprising:
each of said plurality of sealing members in said kit formed of said elastomeric material having a respective consecutively higher shore in a range between 20 A-100 A; and
indicia positioned on each said sealing member in said kit, said indicia identifying a respective said predetermined release pressure for said respective sealing member.

11. The water pump drain plug of claim 9, additionally comprising:
each of said plurality of sealing members in said kit formed of said elastomeric material having a respective consecutively higher shore in a range between 20 A-100 A; and
indicia positioned on each said sealing member in said kit, said indicia identifying a respective said predetermined release pressure for said respective sealing member.

12. The water pump drain plug of claim 1 wherein said predetermined release pressure is 650-800 PSI.
